(19) United States
(12) Patent Application Publication
(10) Pub. No.: US 2024/0414254 A1
(43) Pub. Date: Dec. 12, 2024

(54) ELECTRONIC DEVICE FOR CONTROLLING THAT SIZE OF EXPOSURE AREA OF FLEXIBLE DISPLAY CORRESPONDS TO RATIO OF CONTENT DISPLAY AREA, AND CONTROL METHOD THEREFOR

(71) Applicant: SAMSUNG ELECTRONICS CO., LTD., Suwon-si (KR)

(72) Inventors: Sukdong KIM, Suwon-si (KR); Jihea PARK, Suwon-si (KR); Junghyeob LEE, Suwon-si (KR)

(73) Assignee: SAMSUNG ELECTRONICS CO., LTD., Suwon-si (KR)

(21) Appl. No.: 18/807,605

(22) Filed: Aug. 16, 2024

Related U.S. Application Data
(63) Continuation of application No. PCT/KR2023/002212, filed on Feb. 15, 2023.

(30) Foreign Application Priority Data
Feb. 16, 2022 (KR) 10-2022-0020407
Mar. 21, 2022 (KR) 10-2022-0035011

(51) Int. Cl. H04M 1/02; G06F 3/04842

(52) U.S. Cl. CPC H04M 1/0268; G06F 3/04842; G06F 2203/04102; H04M 1/0237

(57) ABSTRACT

Disclosed is an electronic device including a first housing, a driving circuit provided within the first housing, a second housing provided to be movable with respect to the first housing and overlapping at least a portion of the first housing, and a flexible display at least partially mounted on a surface of the second housing and at least partially exposed to an outside of the electronic device. A portion of the flexible display is inserted into the first housing or exposed from the first housing according to a driving of the driving motor. The electronic device displays at least one image in a first area of the flexible display, and the at least one image includes a second area in which content of the at least one image is displayed, and a third area represented in a first color.

### CROSS-REFERENCE TO RELATED APPLICATIONS

This application is a continuation application of International Application No. PCT/KR2023/002212 designating the United States, filed on Feb. 15, 2023, in the Korean Intellectual Property Receiving Office and claiming priority to Korean Patent Application No. 10-2022-0020407, filed on Feb. 16, 2022, in the Korean Intellectual Property Office, and Korean Patent Application No. 10-2022-0035011, filed on Mar. 21, 2022, in the Korean Intellectual Property Office, the disclosures of which are incorporated by reference herein in their entireties.

### BACKGROUND

### 1. Field

The disclosure relates to an electronic device for controlling the size of an exposed area of a flexible display to correspond to an aspect ratio, and a method for controlling the same.

### 2. Description of Related Art

Services and additional functions have been provided through electronic devices, for example, portable electronic devices such as smart phones. To increase the utility value of these electronic devices and to satisfy the needs of various users, communication service providers or electronic device manufacturers are competitively developing electronic devices to provide various functions and differentiate themselves from other companies. Accordingly, various functions provided through electronic devices become more sophisticated.

In a related art bar-type electronic device (e.g., a smartphone), the size and proportion of a display are fixed, and there may be cases where it is not possible to display a full screen according to the aspect ratio of content provided through the bar-type electronic device (e.g., a black area (e.g., a letterbox) is displayed around a screen). Further, an electronic device with a variable size of an exposed area of a display (e.g., an electronic device including a flexible display) may provide a button for playing a video according to a predetermined aspect ratio (e.g., 16:9), such that when a user selects the button, the electronic device may be controlled to change the length of the flexible display to correspond to the predetermined aspect ratio (e.g., 16:9). Accordingly, as the size of a video screen is provided to substantially correspond to the size of an exposed display area (e.g., to fit the video screen to the exposed display area), a screen without black areas may be provided.

However, aspect ratios (e.g., 16:9 screens) may vary depending on video providers, and content may have multiple aspect ratios even within a single video file. In view of the video providing environment, a related art static aspect ratio change function or operation may result in providing a video including black areas to a user. Moreover, when a video includes black areas for a broadcaster logo or a title image during play, even if the electronic device (e.g., a processor) has information about the aspect ratio of the video being played, this may differ from a screen area actually perceived by the user, and thus a full screen may not be provided in an exposed flexible display area when the video is output. This may mean that information such as an aspect ratio stored in metadata of video content is not sufficient to provide the user with a video that does not include black areas.

### SUMMARY

According to an embodiment of the disclosure, an electronic device may be provided, which is capable of providing a user with an image that fits in an exposed area of a flexible display by identifying a black area included in an image (e.g., a dynamic image) currently being provided via the electronic device through scanning of memory (e.g., a frame buffer), and changing the size of the exposed area of the flexible display to correspond to the size of a screen that does not include the black area.

According to an embodiment of the disclosure, a method for controlling an electronic device may be provided, which is capable of providing a user with an image that fits in an exposed area of a flexible display by identifying a black area included in an image (e.g., a dynamic image) currently being provided via the electronic device through scanning of memory (e.g., a frame buffer), and changing the size of the exposed area of the flexible display to correspond to the size of a screen that does not include the black area.

According to an aspect of the disclosure, there is provided an electronic device including: a first housing; a driving circuit provided within the first housing; a second housing provided to be movable with respect to the first housing and overlapping at least a portion of the first housing; at least one processor provided within the second housing; memory provided within the second housing and operatively connected to the at least one processor; and a flexible display at least partially mounted on a surface of the second housing and at least partially exposed to an outside of the electronic device, wherein a portion of the flexible display is inserted into the first housing or exposed from the first housing according to a driving of the driving motor, wherein the memory is configured to store one or more computer programs, wherein the one or more computer programs include computer-executable instructions that, when executed by the at least one processor, cause the electronic device to: display at least one image in a first area of the flexible display, wherein the at least one image includes a second area in which content of the at least one image is displayed, and a third area represented in a first color, identify an occurrence of an event for controlling a size of the first area of the flexible display to correspond to a size of the second area, based on identifying the event, identify a size of the second area by scanning the memory, and control the driving circuit to change the size of the first area to correspond to the size of the second area, based on the identified size of the third area.

The computer-executable instructions, when executed by the at least one processor, may cause the electronic device to identify a closed section corresponding to the third area by sequentially identifying pixel data stored in the memory.

The event may include at least one of an event of a touch input on a visual object displayed on the flexible display or an event of the size of the third area being changed.

The computer-executable instructions, when executed by the at least one processor, may cause the electronic device to, based on a ratio of the content being less than a ratio of the first area, change the size of the first area by controlling the driving circuit to reduce a horizontal length of the flexible display corresponding to the third area.

The computer-executable instructions, when executed by the at least one processor, may cause the electronic device to, based on a ratio of the content being larger than a ratio of the first area, change the size of the first area by controlling the driving circuit to increase a horizontal length of the flexible display corresponding to the third area.

The computer-executable instructions, when executed by the at least one processor, may cause the electronic device to, based on the second area including the first color, control the driving circuit to display an image included in a remaining area except for an area including the first color.

The memory may be configured to store pixel data of a black color corresponding to the first color.

The computer-executable instructions, when executed by the at least one processor, may cause the electronic device to identify a length of the flexible display corresponding to the size of the third area.

The computer-executable instructions, when executed by the at least one processor, may cause the electronic device to calculate a movement distance of the driving circuit based on the length of the flexible display corresponding to the size of the third area.

The computer-executable instructions, when executed by the at least one processor, may cause the electronic device to display first content by scaling up the displayed first content in the changed first area.

According to an aspect of the disclosure, there is provided a method for controlling an electronic device including displaying at least one image in a first area of a flexible display of the electronic device, wherein the at least one image includes a second area in which content of the at least one image is displayed, and a third area represented in a first color; identifying an occurrence of an event for controlling a size of the first area of the flexible display to correspond to a size of the first area; based on identifying the event, identifying a size of the third area by scanning memory of the electronic device, and controlling a driving circuit of the electronic device to change the size of the first area to correspond to the size of the first area, based on the identified size of the third area.

The method may include identifying a closed section corresponding to the third area by sequentially identifying pixel data stored in the memory.

The event includes at least one of an event of a touch input to a visual object displayed on the flexible display or an event of the size of the third area being changed.

The method may include, based on a ratio of the content being less than a ratio of the first area, changing the size of the first area by controlling the driving circuit to reduce a horizontal length of the flexible display corresponding to the third area.

The method may include, based on a ratio of the content being larger than a ratio of the first area, changing the size of the first area by controlling the driving circuit to increase a horizontal length of the flexible display corresponding to the third area.

According to an embodiment of the disclosure, an electronic device may be provided, which is capable of providing a user with an image that fits in an exposed area of a flexible display by identifying a black area included in an image (e.g., a dynamic image) currently being provided via the electronic device through scanning of memory (e.g., a frame buffer), and changing the size of the exposed area of the flexible display to correspond to the size of a screen that does not include the black area.

Effects of one or more embodiments of the disclosure are not limited to those described above, and it will be apparent to those skilled in the art that various effects lie within the disclosure.

### BRIEF DESCRIPTION OF DRAWINGS

The above and other aspects and/or features of one or more embodiments of the disclosure will be more apparent from the following detailed description, taken in conjunction with the accompanying drawings, in which:

FIG. 1 is a block diagram illustrating an electronic device in a network environment according to one or more embodiments of the disclosure;

FIG. 2 is an exemplary diagram illustrating a state in which a second display area of a display is accommodated in a second housing according to one or more embodiments of the disclosure;

FIG. 3A is an exemplary diagram illustrating a state in which a second display area of a display is exposed to the outside of a second housing according to one or more embodiments of the disclosure;

FIG. 3B is an exploded perspective view illustrating an electronic device according to one or more embodiments of the disclosure;

FIG. 4A is a cross-sectional view illustrating associated configurations of a rack and a gear connected to a motor in a closed state of an electronic device according to one or more embodiments of the disclosure;

FIG. 4B is a cross-sectional view illustrating an arrangement relationship between a motor and a battery in a closed state of an electronic device according to one or more embodiments of the disclosure;

FIG. 5A is a cross-sectional view illustrating associated configurations of a rack and a gear connected to a motor in an opened state of an electronic device according to one or more embodiments of the disclosure;

FIG. 5B is a cross-sectional view illustrating an arrangement relationship between a motor and a battery in an opened state of an electronic device according to one or more embodiments of the disclosure;

FIG. 6 is an exemplary diagram illustrating a phenomenon in which a letterbox area (e.g., a black area) is displayed, when the aspect ratio of an image (e.g., content) is smaller than the size ratio of a display (e.g., a flexible display) (e.g., when the aspect ratio of the content is 16:9 and the size ratio of the display is 21:9) according to an embodiment of the disclosure;

FIG. 7 is an exemplary diagram illustrating a phenomenon in which a letterbox area (e.g., a black area) is displayed, when the aspect ratio of an image (e.g., content) is larger than the size ratio of a display (e.g., a flexible display) (e.g., when the aspect ratio of the content is 16:9 and the size ratio of the display is 4:3) according to an embodiment of the disclosure;

FIGS. 8A and 8B are exemplary diagrams illustrating cases in which a black area is included in a content display area according to an embodiment of the disclosure;

FIG. 9 is an exemplary diagram illustrating a function or operation of controlling the size of an exposed area of a flexible display to fit the size of a content display area by an electronic device (e.g., a processor) according to an embodiment of the disclosure;

FIGS. 10A, 10B, and 10C are exemplary diagrams illustrating a function or operation of triggering a function or operation of controlling the size of an exposed area of a flexible display to fit the size of a content display area according to a user input by an electronic device (e.g., a processor) according to an embodiment of the disclosure;

FIG. 11A is an exemplary diagram illustrating image data (e.g., combination values of pixel intensities and/or RGB data) stored in memory (e.g., a frame buffer) in correspondence with an image being output according to an embodiment of the disclosure;

FIG. 11B, FIG. 11C, FIG. 11D, FIG. 11E, and FIG. 11F are exemplary diagrams illustrating a function or operation of labeling image data according to an embodiment of the disclosure;

FIG. 12A is an exemplary diagram illustrating a function or operation of controlling the size of an exposed area of a flexible display to fit the size of a content display area by reducing a horizontal length of the exposed flexible display area according to an embodiment of the disclosure;

FIG. 12B is an exemplary diagram illustrating a function or operation of controlling the size of an exposed area of a flexible display to fit the size of a content display area by increasing a horizontal length of the exposed flexible display area according to an embodiment of the disclosure; and

FIGS. 13A and 13B are exemplary diagrams illustrating a function or operation of controlling a driving module to prevent a letterbox area from being displayed, when an image is displayed in a vertical orientation (e.g., portrait orientation) by an electronic device according to an embodiment of the disclosure.

### DETAILED DESCRIPTION

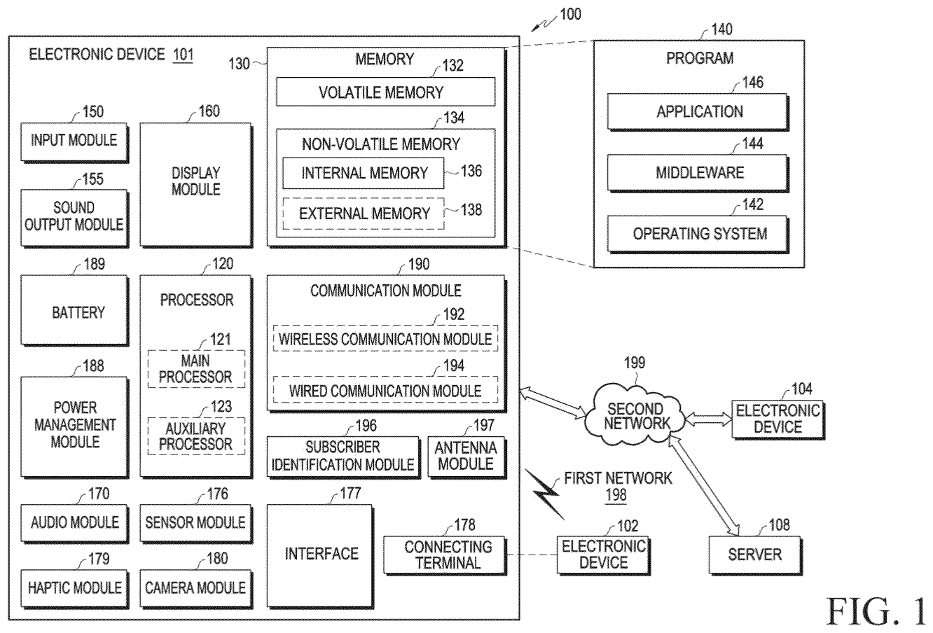

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

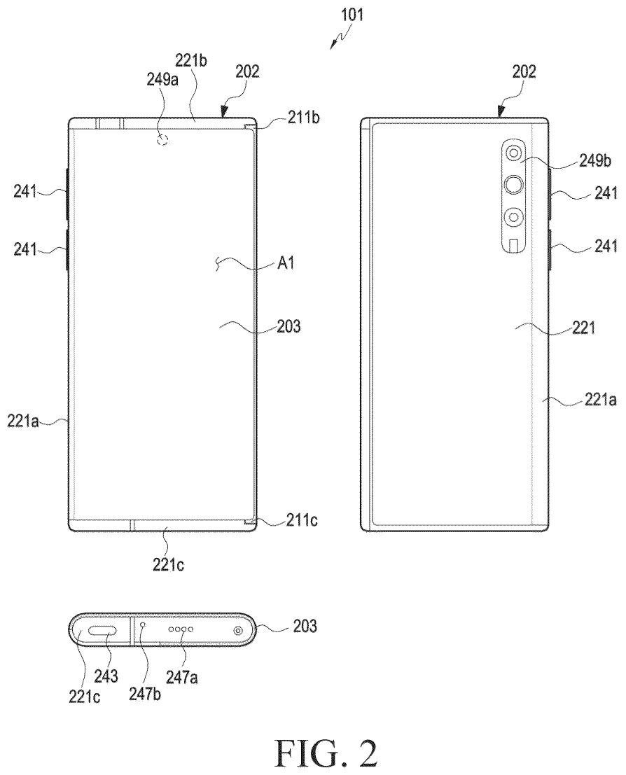

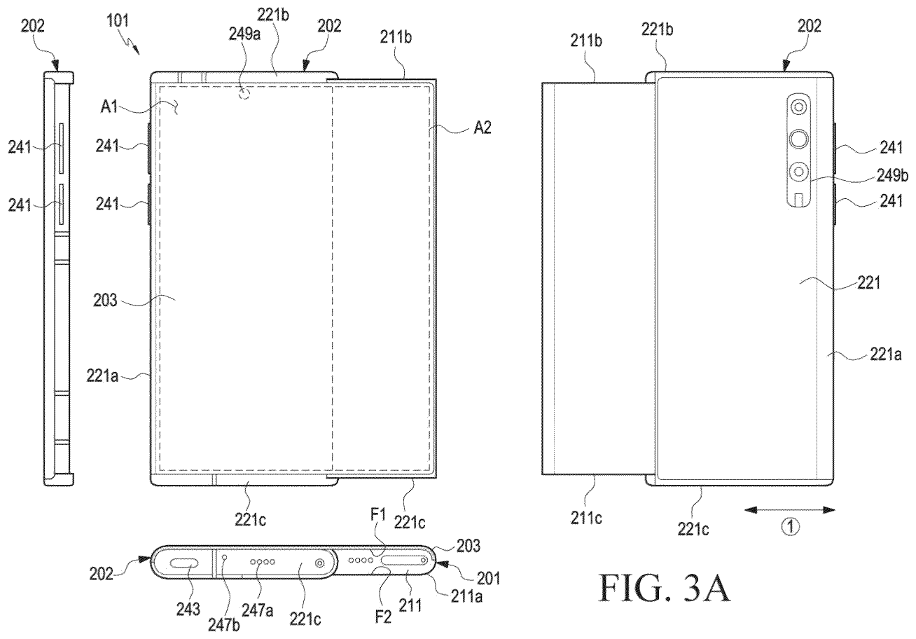

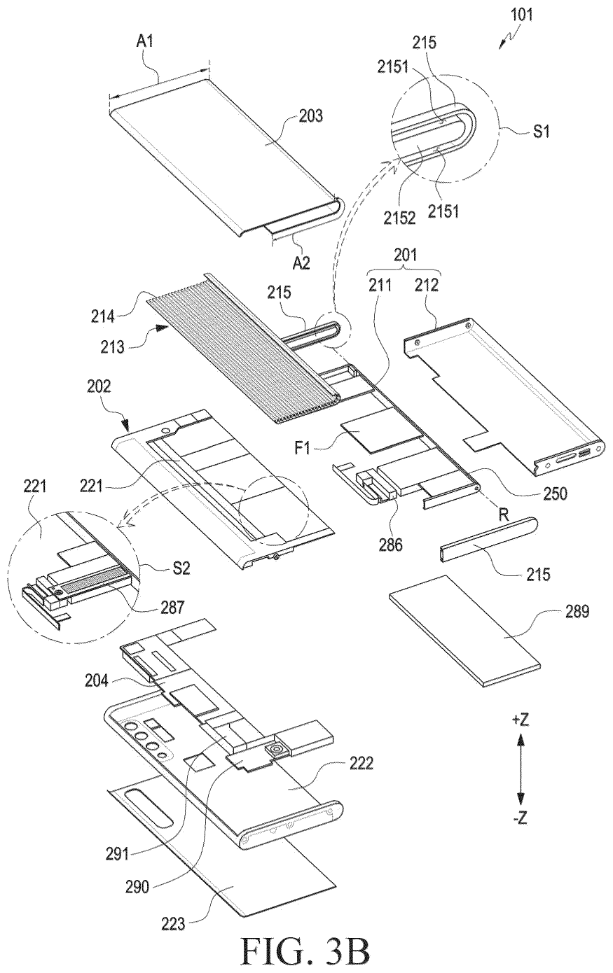

FIG. 2 is a diagram illustrating a state in which a second display area of a display is accommodated in a second housing according to one of various embodiments of the disclosure. FIG. 3A is a diagram illustrating a state in which the second display area of the display is exposed to the outside of the second housing according to one of various embodiments of the disclosure.

FIGS. 2 and 3A illustrate a structure in which a display 203 (e.g., a flexible display) extends in a right direction, when viewed from the front surface of the electronic device 101. However, the direction of extension of the display 203 is not limited to one direction (e.g., right direction), and a design modification may be made to the display 203 such that the display 203 is extendable in the left direction and/or both directions.

The state illustrated in FIG. 2 may be defined as a first housing 201 being closed with respect to a second housing 202, and the state illustrated in FIG. 3 may be defined as the first housing 201 being open with respect to the second housing 202. According to an embodiment, a “closed state” or an “opened state” may be defined as a state in which an electronic device is closed or opened.

Referring to FIGS. 2 and 3A, the electronic device 101 may include a housing 201 and 202. The housing 201 and 202 may include the second housing 202 and the first housing 201 movable with respect to the second housing 202. In some embodiments, it may be interpreted as a structure in which the second housing 202 is disposed slidably on the first housing 201 in the electronic device 101. According to an embodiment, the first housing 201 may be disposed to be reciprocable by a predetermined distance in a direction illustrated with respect to the second housing 202, for example, in a direction indicated by an arrow (1).

According to various embodiments, the first housing 201 may be referred to as, for example, a first structure, a slide part, or a slide housing, and disposed to be reciprocable on the second housing 202. According to an embodiment, the first housing 201 may accommodate various electric and electronic components such as a circuit board or a battery. The second housing 202 may be referred to as, for example, a second structure, a main part, or a main housing, and guide movement of the first housing 201. A portion (e.g., a first display area A1) of a display 203 may be seated in the first housing. According to an embodiment, as the first housing 201 moves (e.g., slides) with respect to the second housing 202, another portion (e.g., a second display area A2) of the display 203 may be accommodated into the second housing 202 (e.g., a slide-in operation) or visually exposed to the outside of the second housing 202 (e.g., a slide-out operation). According to an embodiment, a motor, a speaker, a SIM socket, and/or a sub-circuit board electrically connected to a main circuit board may be disposed within the first housing 201. The main circuit board with electrical components such as an AP and a CP mounted thereon may be disposed within the second housing 202.

According to various embodiments, the first housing 201 may include a first plate 211 (e.g., slide plate). The first plate 211 may include a first surface (e.g., a first surface F1 in FIG. 3A) and a second surface F2 facing in an opposite direction of the first surface F1. According to an embodiment, the first plate 211 may support at least a portion (e.g., the first display area A1) of the display 203. According to an embodiment, the first housing 201 may include the first plate 211, a (1-1)^{th} sidewall 211a extending from the first plate 211, a (1-2)^{th} sidewall 211b extending from the (1-1)^{th} sidewall 211a and the first plate 211, and a (1-3)^{th} sidewall 211c extending from the (1-1)^{th} sidewall 211a and the first plate 211 and substantially parallel to the (1-2)^{th} sidewall 211b.

According to various embodiments, the second housing 202 may include a second plate 221 (e.g., a main case), a (2-1)^{th} sidewall 221a extending from the second plate 221, a (2-2)^{th} sidewall 221b extending from the (2-1)^{th} sidewall 221a and the second plate 221, and a (2-3)^{th} sidewall 221c extending from the (2-1)^{th} sidewall 221a and the second plate 221 and substantially parallel to the (2-2)^{th} sidewall 221b. According to an embodiment, the (2-3)^{th} sidewall 221c and the (2-2)^{th} sidewall 221b may be substantially perpendicular to the (2-1)^{th} sidewall 221a. According to an embodiment, each of the second plate 221, the (2-1)^{th} sidewall 221a, the (2-2)^{th} sidewall 221b, and the (2-3)^{th} sidewall 221c may be formed with one side (e.g., a front surface) open to accommodate (or surround) at least a portion of the first housing 201. For example, the first housing 201 may be coupled to the second housing 202, at least partially surrounded by the second housing 202, and may slide in a direction parallel to the first surface F1 or the second surface F2, for example, in the direction of the arrow \textcircled{1} while being guided by the second housing 202. According to an embodiment, the second plate 221, the (2-1)^{th} sidewall 221a, the (2-2)^{th} sidewall 221b, and/or the (2-3)^{th} sidewall 221c may be integrally formed. According to another embodiment, the second plate 221, the (2-1)^{th} sidewall 221a, the (2-2)^{th} sidewall 221b, and/or the (2-3)^{th} sidewall 221c may be formed as separate housings and combined or assembled.

According to an embodiment, the second plate 221 and/or the (2-1)^{th} sidewall 221a may cover at least a portion of the display 203. For example, at least a portion of the display 203 may be accommodated into the second housing 202, and the rear plate 221 and/or the (2-1)^{th} sidewall 221a may cover the portion of the display 203 accommodated in the second housing 202.

According to various embodiments, the first housing 201 is movable to the opened state or the closed state with respect to the second housing 202 in a first direction (e.g., the direction \textcircled{1}) parallel to the (2-2)^{th} sidewall 221b or the (2-3)^{th} sidewall 221c, and movable to be located at a first distance from the (2-1)^{th} sidewall 221a in the closed state and at a second distance larger than the first distance from the (2-1)^{th} sidewall 221a in the opened state. In some embodiments, the first housing 201 may surround a portion of the (2-1)^{th} sidewall 221a in the closed state.

According to various embodiments, the electronic device 101 may include the display 203, key input devices 241, a connector hole 243, audio modules 247a and 247b, or camera modules 249a and 249b. Although not shown, the electronic device 101 may further include an indicator (e.g., an LED device) or various sensor modules.

According to various embodiments, the display 203 may include the first display area A1 and the second display area A2. According to an embodiment, the first display area A1 may be disposed on the second housing 202. The second display area A2 may extend from the first display area A1, and may be inserted or accommodated into the second housing 202 (e.g., a structure) or exposed to the outside of the second housing 202 according to sliding movement of the first housing 201.

According to various embodiments, the second display area A2 may move while being guided substantially by a first area (e.g., a curved surface 250 in FIG. 3B) of the first housing 201 to be accommodated into or exposed to the outside of the second housing 202 or a space formed between the first housing 201 and the second housing 202. According to an embodiment, the second display area A2 may move based on sliding movement of the first housing 201 in the first direction (e.g., the direction indicated by the arrow 0). For example, a portion of the second display area A2 may be deformed into a curved surface at a position corresponding to the curved surface 250 of the first housing 201 during the sliding movement of the first housing 201.

According to various embodiments, when viewed from above the first plate 211 (e.g., slide plate), as the first housing 201 moves from the closed state to the opened state, the second display area A2 may gradually be exposed to the outside of the second housing 202 and form a substantially flat surface with the first display area A1. The display 203 may be coupled to or disposed adjacent to a touch sensing circuit, a pressure sensor capable of measuring the intensity (pressure) of a touch, and/or a digitizer that detects a magnetic stylus pen. In an embodiment, the second display area A2 may be at least partially accommodated into the second housing 202, and even in the state (e.g., the closed state) illustrated in FIG. 2, a portion of the second display area A2 may be visually exposed to the outside. According to an embodiment, regardless of the closed or opened state, the exposed portion of the second display area A2 may be located on a portion (e.g., the curved surface 250 of FIG. 3B) of the first housing, and maintain a curved surface shape at the position corresponding to the curved surface 250.

According to one of various embodiments, the electronic device 101 may include at least one hinge structure. The hinge structure 240 may connect the first housing 201 and the second housing 202 to each other. For example, the hinge structure 240 may be connected to the first plate 211 and the second plate 221. According to an embodiment, the hinge structure 240 may transmit a driving force to the first housing 201 to guide sliding movement of the first housing 201. For example, the hinge structure 240 may include an elastic material (e.g., a spring) and provide an elastic force in the first direction (e.g., the direction®) in FIG. 3A) based on the sliding movement of the first housing 201. According to an embodiment, the hinge structure 240 may be excluded.

According to various embodiments, the key input devices 241 may be located in an area of the first housing 201. Depending on the appearance and a use state, the electronic device 101 may be designed to be without the illustrated key input devices 241 or to include additional key input device(s). According to an embodiment, the electronic device 101 may include a key input device not shown, such as a home key button or a touch pad disposed around the home key button. According to another embodiment, at least some of the key input devices 241 may be disposed on the (2-1)^{th} sidewall 221a, the (2-2)^{th} sidewall 221b, or the (2-3)^{th} sidewall 221c of the second housing 202.

According to various embodiments, the connector hole 243 may be omitted according to an embodiment, and may accommodate a connector (e.g., a USB connector) for transmitting power and/or data to and from an external electronic device. Although not shown, the electronic device 101 may include a plurality of connector holes 243, and some of the plurality of connector holes 243 may function as connector holes for transmitting and receiving audio signals to and from an external electronic device. In the illustrated embodiment, the connector hole 243 is disposed on the (2-3)^{th} sidewall 221c, to which the disclosure is not limited. The connector hole 243 or a connector hole not shown may be disposed on the (2-1)^{th} sidewall 221a or the (2-2)^{th} sidewall 221b.

According to various embodiments, the audio modules 247a and 247b may include at least one speaker hole 247a or at least one microphone hole 247b. One of the speaker holes 247a may be provided as a receiver hole for voice calls, and the other may be provided as an external speaker hole. The electronic device 101 may include a microphone for obtaining sound, and the microphone may obtain sound external to the electronic device 101 through the microphone hole 247b. According to an embodiment, the electronic device 101 may include a plurality of microphones to detect the direction of sound. According to an embodiment, the electronic device 101 may include an audio module in which the speaker hole 247a and the microphone hole 247b are implemented as a single hole, or include a speaker (e.g., a piezo speaker) without the speaker hole 247a.

According to various embodiments, the camera modules 249a and 249b may include a first camera module 249a and a second camera module 249b. The second camera module 249b may be located in the first housing 201 and capture a subject from a direction opposite to the first display area A1 of the display 203. The electronic device 101 may include a plurality of camera modules 249a and 249b. For example, the electronic device 101 may include at least one of a wide-angle camera, a telephoto camera, or a close-up camera, and according to an embodiment, include an IR projector and/or an IR receiver to measure a distance to a subject. The camera modules 249a and 249b may include one or more lenses, an image sensor, and/or an image signal processor. The first camera module 249a may be disposed to face in the same direction as the display 203. For example, the first camera module 249a may be disposed around the first display area A1 or in an area that overlaps the display 203 and, when disposed in the area that overlaps the display 203, may be able to capture a subject through the display 203. According to an embodiment, the first camera module 249a may not be visually exposed to a screen display area (e.g., the first display area A1) and include a hidden under display camera (UDC).

According to various embodiments, an indicator (not shown) of the electronic device 101 may be disposed in the first housing 201 or the second housing 202, and include an LED to provide state information about the electronic device 101 as a visual signal. A sensor module (not shown) of the electronic device 101 may generate an electrical signal or data value corresponding to an internal operational state or an external environmental state of the electronic device 101. The sensor module may include, for example, a proximity sensor, a fingerprint sensor, or a biometric sensor (e.g., an iris/facial recognition sensor or HRM sensor). In another embodiment, the sensor module may further include at least one of, for example, a gesture sensor, a gyro sensor, a barometric pressure sensor, a magnetic sensor, an acceleration sensor, a grip sensor, a color sensor, an IR sensor, a temperature sensor, a humidity sensor, or an illuminance sensor.

FIG. 3B is an exploded perspective view illustrating an electronic device according to various embodiments of the disclosure.

Referring to FIG. 3B, the electronic device 101 may include the first housing 201, the second housing 202, the display 203 (e.g., a flexible display, a foldable display, or a rollable display), and a support structure 213 (e.g., a multi-joint hinge structure). A portion (e.g., the second display area A2) of the display 203 may be accommodated into the electronic device 101 along the curved surface 250 of the first housing 201.

The configurations of the first housing 201, the second housing 202, and the display 203 in FIG. 3B may be wholly or partially the same as those of the first housing 201, the second housing 202, and the display 203 in FIGS. 2 and 3A.

According to various embodiments, the first housing 201 may include the first plate 211 and a slide cover 212. The first plate 211 and the slide cover 212 may be mounted on (e.g., at least partially connected to) the second housing 202, and reciprocate in a straight line in one direction (e.g., in the direction of the arrow (1 in FIGS. 2 and 3a), while being guided by the second housing 202. According to an embodiment, the first plate 211 may support the display 203. For example, the first plate 211 may include the first surface F1, and the first display area A1 of the display 203 may be substantially located on the first surface F1 and maintained in the form of a flat plate. The slide cover 212 may protect the display 203 located on the first plate 211. For example, at least a portion of the display 203 may be located between the first plate 211 and the slide cover 212. According to an embodiment, the first plate 211 and the slide cover 212 may be formed of a metallic material and/or a non-metallic (e.g., polymer) material. According to an embodiment, the first plate 211 may accommodate at least some (e.g., a battery 289, a driving motor 286, and a rack 287) of the components of the electronic device 101.

According to various embodiments, the support structure 213 may be connected to the first housing 201. For example, the support structure 213 may be located between the first plate 211 and the slide cover 212. According to an embodiment, as the first housing 201 slides, the support structure 213 may move with respect to the second housing 202. When the support structure 213 is in the closed state (e.g., FIG. 2), most of the structure may be accommodated inside the second housing 202. According to an embodiment, at least a portion of the support structure 213 may move in correspondence with the curved surface 250 located at an edge of the first housing 201.

According to various embodiments, the support structure 213 may include a plurality of bars (or rods) 214 and guide rails 215. The plurality of bars 214 may extend in a straight line, be disposed parallel to a rotation axis R formed by the curved surface 250, and be arranged along a direction substantially perpendicular to the rotation axis R (e.g., along a direction in which the first housing 201 slides).

According to various embodiments, the guide rails 215 may guide movement of the plurality of bars 214. The guide rails 215 may include a top guide rail coupled to a top end of the first plate 211 and connected to top end portions of the plurality of bars 214, and a bottom guide rail coupled to a bottom end of the first plate 211 and connected to bottom end portions of the plurality of bars 214. According to an embodiment, referring to a first enlarged area S1, when the plurality of bars 214 are bent or slid across the curved surface 250, the top end portions and/or bottom end portions of the plurality of bars 214 may move while being fit-coupled to a guide rail 215. For example, the top end portions and/or bottom end portions of the plurality of bars 214 may slide along a groove-shaped rail 2151, while being fit-coupled to the rail 2151 formed on the inside of the guide rail 215.

According to an embodiment, by driving of the motor 286 (e.g., driving for display slide-out), the first plate 211 with the motor 286 disposed thereon may slide out, and a protruding portion 2152 on the inside of the guide rail 215 may push out the top end portions and/or bottom end portions of the plurality of bent bars 214. Accordingly, the display 203 accommodated between the first plate 211 and the slide cover 212 may extend to the front. According to an embodiment, by driving of the motor 286 (e.g., driving for display slide-in), the first plate 211 with the motor 286 disposed thereon may slide in, and an outer portion (e.g., a portion other than the protruding portion 2152) of the guide rail 215 may push out the top end portions and/or bottom end portions of the plurality of bars 214 that are bent. Accordingly, the extended display 203 may be accommodated between the first plate 211 and the slide cover 212.

According to an embodiment, the rack 287 may be disposed within the second housing 202 and guide sliding movement of the first housing 201 and the display 203. A second enlarged area S2 illustrates a rear surface (e.g., a surface facing a −Z axis) of the second plate 221. Referring to the second enlarged area S2, the rack 287 may be fixedly disposed on one surface (e.g., the surface facing the −Z axis) of the second plate 221 of the second housing 202, and guide a gear connected to the driving motor 286 to rotatingly move in a sliding direction. According to another embodiment, the rack 287 may be disposed within the first housing 201, and the motor 286 may be disposed within the second housing 202. The rack 287 may guide sliding movement of the second housing 202 and the display 203. For example, the rack 287 may be fixedly disposed on the first plate 211 of the first housing 201 and slide in rotation with the gear connected to the driving motor 286 disposed on the second plate 221 of the second housing 202. According to various embodiments, the second housing 202 may include the second plate 221, a second plate cover 222, and a third plate 223. The second plate 221 may support the electronic device 101 as a whole. The second plate 221 may have one surface on which the first plate 211 is disposed and the other surface coupled to a PCB 204. According to an embodiment, the second plate 221 may accommodate components (e.g., the battery 289 and the circuit board 204) of the electronic device 101. The second plate cover 222 may protect various components located on the second plate 221.

According to various embodiments, there may be a plurality of substrates accommodated in the second housing 202. A processor, memory, and/or an interface may be mounted on the circuit board 204 as a main board. The processor may include at least one of, for example, a CPU, an AP, a GPU, an ISP, a sensor hub processor, or a CP. According to various embodiments, the circuit board 204 may include a flexible printed circuit board type radio frequency cable (FRC). For example, the circuit board 204 may be disposed on at least a portion of the second plate 221 and electrically connected to an antenna module and a communication module.

According to an embodiment, the memory may include, for example, volatile memory or non-volatile memory.

According to an embodiment, the interface may include, for example, a high definition multimedia interface (HDMI), a universal serial bus (USB) interface, an SD card interface, and/or an audio interface. The interface may electrically or physically connect the electronic device 101 to an external electronic device, for example, and include a USB connector, an SD card/MMC connector, or an audio connector.

According to various embodiments, the electronic device 101 may further include a separate sub-circuit board 290 spaced apart from the circuit board 204 within the second housing 202. The sub-circuit board 290 may be electrically connected to the circuit board 204 via a connecting flexible board 291. The sub-circuit board 290 may be electrically connected to electrical components disposed in an end area of the electronic device 101, such as the battery 289 or a speaker, and/or a SIM socket, and transmit signals and power to them.

According to various embodiments, the battery 289, which is a device for supplying power to at least one component of the electronic device 101, may include, for example, a non-rechargeable primary cell, a rechargeable secondary cell, or a fuel cell. At least a portion of the battery 289 may be disposed on substantially the same plane with the circuit board 204, for example. The battery 289 may be disposed integrally within the electronic device 101 or detachably from the electronic device 101.

According to an embodiment, the battery 289 may be formed as a single integrated battery or include a plurality of separate batteries. For example, when the integrated battery is located on the first plate 211, it may move along with sliding movement of the first plate 211.

According to various embodiments, the third plate 223 may substantially form at least a portion of the exterior of the second housing 202 or the electronic device 101. For example, the third plate 223 may be coupled to an outer surface of the second plate cover 222. According to an embodiment, the third plate 223 may be integrally formed with the second plate cover 222. According to an embodiment, the third plate 223 may provide a decorative effect on the exterior of the electronic device 101. The second plate 221 and the second plate cover 222 may be fabricated using at least one of metal or polymer, and the third plate 223 may be fabricated using at least one of metal, glass, synthetic resin, or ceramic. According to an embodiment, the second plate 221, the second plate cover 222, and/or the third plate 223 may be at least partially (e.g., an auxiliary display area) made of a material that transmits light. For example, with a portion (e.g., the second display area A2) of the display 203 accommodated in the electronic device 101, the electronic device 101 may output visual information using the second display area A2. The second display area may be a portion of the second plate 221, the second plate cover 222, and/or the third plate 223 on which the display 203 accommodated in the second housing 202 is located.

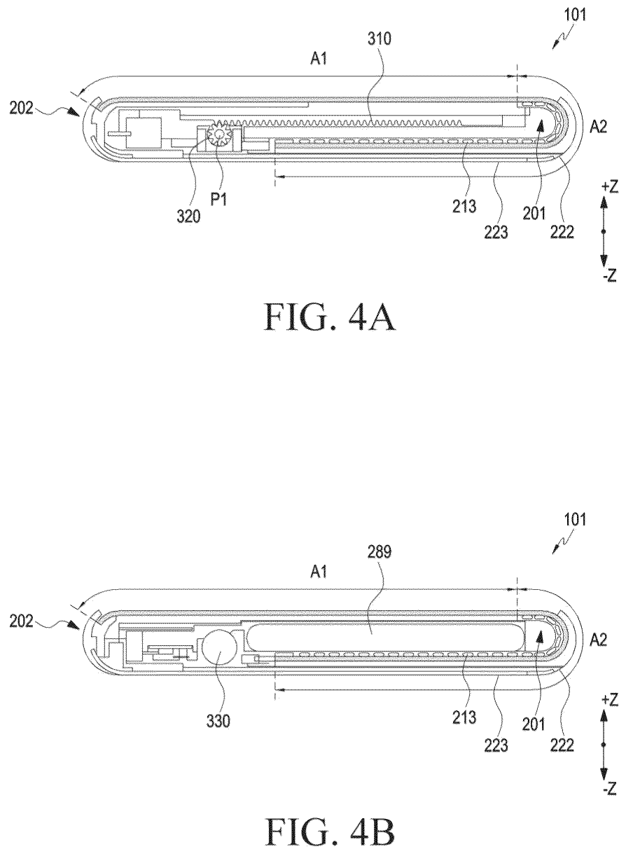

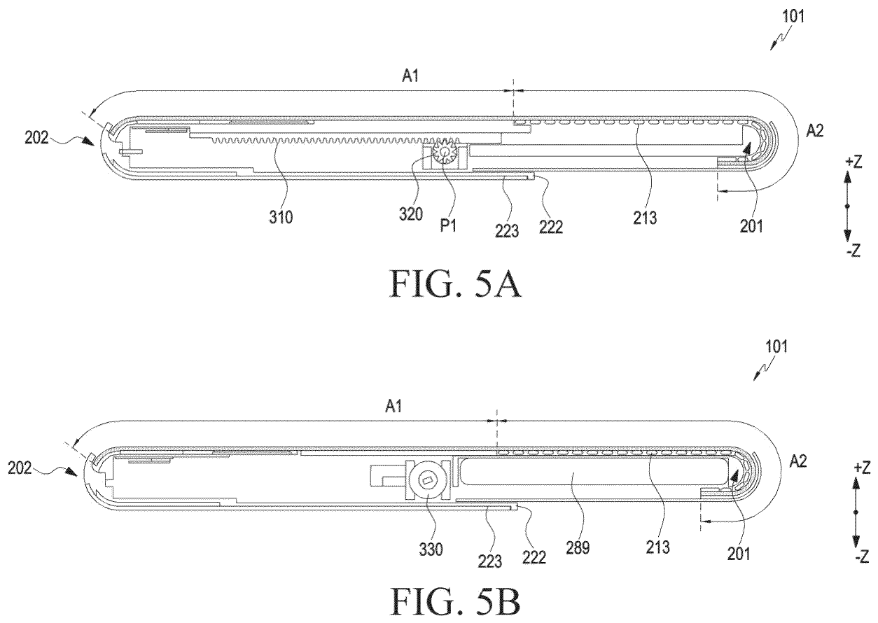

FIG. 4A is a cross-sectional view illustrating associated configurations of a rack and a gear connected to a motor in a closed state of an electronic device according to various embodiments of the disclosure. FIG. 4B is a cross-sectional view illustrating an arrangement relationship between a motor and a battery in a closed state of an electronic device according to various embodiments of the disclosure. FIG. 5A is a cross-sectional view illustrating an association configuration of a rack and a gear connected to a motor in an opened state of an electronic device according to various embodiments of the disclosure. FIG. 5B is a cross-sectional view illustrating an arrangement relationship between a motor and a battery in an opened state of an electronic device according to various embodiments of the disclosure.

According to various embodiments, the electronic device 101 may include the first housing 201, the second housing 202, the display 203, and a drive structure. The electronic device 101 may further include various components disposed within the first housing 201 or the second housing 202, such as a camera module and a battery.

The configurations of the first housing 201 and the second housing 202 in FIGS. 4A to 5B may be wholly or partially the same as those of the first housing 201 and the second housing 202 in FIGS. 2A to 3B.

According to various embodiments, as the second housing 202 slides in and out with respect to the first housing 201, the first housing 201 (and the flexible display 203 connected to the first housing 201) may be in the closed state or the opened state.

According to various embodiments, the electronic device 101 may include the drive structure to automatically or semi-automatically provide the slide-in and slide-out operations of the display 203. For example, when a user presses an open trigger button (e.g., a key input device 241 in FIG. 2) exposed to the outside of the electronic device 101, the display 203 may automatically slide in or out (automatic operation). In another example, when the user slides out the display 203 of the electronic device 101 by pushing it to a specified section, the remaining section may fully slide out under the force of an elastic member mounted within the electronic device 101 (semi-automatic operation). A slide-in operation of the electronic device 101 may also be performed to correspond to the slide-out operation (semi-automatic operation).

According to an embodiment, the drive structure may include a driving motor 330, a gear 320 mounted on an end of the driving motor 330, a rack 310, and a connecting board (not shown) electrically connected to the driving motor 330.

According to an embodiment, the driving motor 330 may be disposed within the first housing 201 and formed to be slidable with respect to the second housing 202. The driving motor 330 may transmit a driving force to the gear 320 connected to the end thereof.

According to an embodiment, the driving motor 330 may be disposed so as not to overlap the second display area A2 of the display 203. For example, an axis P1 of the driving motor 330 may be disposed perpendicular to the sliding direction, and although a surface of the driving motor 330 facing a +Z-axis direction overlaps the first display area A1, a surface of the driving motor 330 facing a −Z-axis direction may be disposed so as not to overlap the second display area A2, regardless of the slide-in and slide-out of the display 203. The surface of the driving motor 330 facing the −Z-axis direction may face the first housing 201 in the slide-in state of the display 203, and face the second housing 202 in the slide-out state of the display 203. According to an embodiment, the driving motor 330 may be disposed parallel to at least a portion of the battery 289 and electrically connected to the connecting board disposed adjacent to the driving motor 330.

According to an embodiment, the rack 310 may be disposed within the second housing 202 and guide sliding movement of the first housing 201 and the display 203. The rack 310 may be fixedly disposed on one surface (e.g., a surface facing the −Z axis) of the second plate 221 of the second housing 202 and guide the gear 320 to rotatingly move in the direction of the sliding movement. At least a portion of the surface of the rack 310 facing the −Z-axis direction may face the second display area A2 in the slide-in state of the display 203, and may not face the second display area A2 in the slide-out state of the display 203. According to an embodiment, the rack 310 may be disposed not to overlap the battery 289. For example, detachable batteries may be disposed within the electronic device 101, and when viewed toward the rear surface thereof, the rack 310 may be located between the batteries.

According to an embodiment, the gear 320 may be located on the axis P1 of the driving motor 330, and slide the first housing 201 and the display 203, while rotatingly moving along the rack 310. When the first housing 201 slides by rotation of the gear 320, an electrical component (hereinafter referred to as a first electrical component) mounted within the first housing 201 may also slide. For example, the first electrical component may be at least one of the driving motor 330, components disposed on a connecting board, a speaker, or a SIM socket. In another example, the first electrical component may be the battery 289. In the case of detachable batteries, it may be at least one of the detachable batteries.

According to an embodiment, the connecting board 340 may be disposed within the first housing 201, adjacent to the driving motor 330 and/or the rack 310. The connecting board 340 may be a component for electrical connection to the main circuit board (e.g., the circuit board 204 in FIG. 3B) disposed in the second housing 202. The main circuit board may have an electrical structure (e.g., a processor) mounted thereon to control the driving of the driving motor 330 or to provide power to the driving motor 330. The connecting board may be electrically connected to the main circuit board 204 and transmit a signal for controlling the driving of the driving motor 330 or controlling power. According to an embodiment, the connecting board and the main circuit board 204 may be rigid boards, and the electronic device 101 may further include a separate connecting FPCB to connect the connecting board and the main circuit board 204 to each other. In another embodiment, power may be provided to the driving motor 330 and the battery 289 disposed adjacent to it, directly through the connecting board.

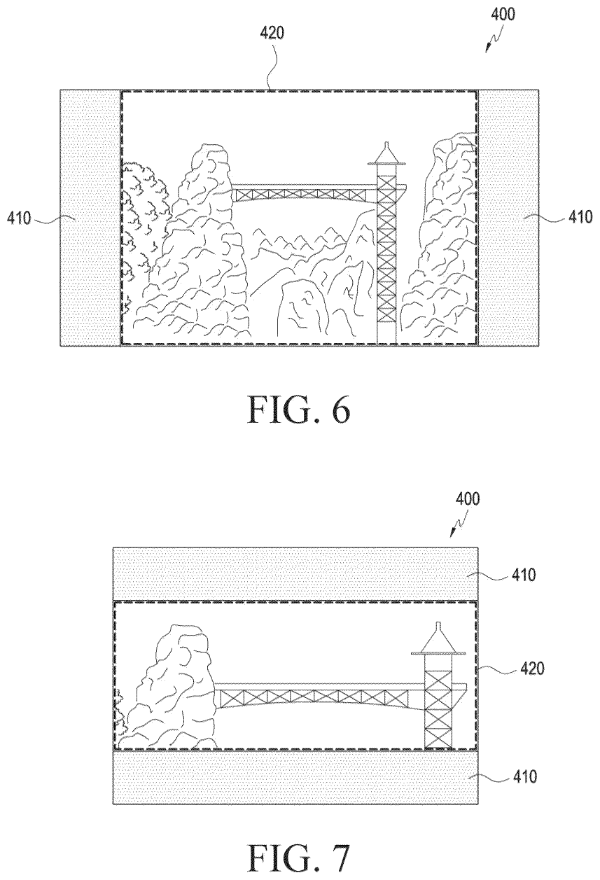

FIG. 6 is an exemplary diagram illustrating a phenomenon in which letterbox areas (e.g., black areas) 410 are displayed, when the aspect ratio of an image (e.g., content) is smaller than the size ratio of a display (e.g., a flexible display) (e.g., when the aspect ratio of the content is 16:9 and the size ratio of the display is 21:9) according to an embodiment of the disclosure. FIG. 7 is an exemplary diagram illustrating a phenomenon in which the letterbox areas (e.g., black areas) 410 are displayed, when the aspect ratio of an image (e.g., content) is larger than the size ratio of a display (e.g., a flexible display) (e.g., when the aspect ratio of the content is 16:9 and the size ratio of the display is 4:3) according to an embodiment of the disclosure.

Referring to FIG. 6, when the aspect ratio of content is smaller than the size ratio of the display module 160 (e.g., a flexible display) (e.g., when the aspect ratio of the content is 16:9 and the size ratio of the display module 160 is 21:9), the electronic device 101 according to an embodiment of the disclosure may display a specified color (e.g., black) around a content display area 420 (e.g., in areas to the left and right of the content display area 420) where content of an image is displayed, as illustrated in FIG. 6. The specified color according to an embodiment of the disclosure may be displayed in the letterbox areas 410. Referring to FIG. 7, the aspect ratio of content is larger than the size ratio of the display module 160 (e.g., a flexible display) (e.g., when the aspect ratio of the content is 16:9 and the size ratio of the display module 160 is 4:3), the electronic device 101 according to an embodiment of the disclosure may display a specified color (e.g., black) around the content display area 420 (e.g., in areas above and below the content display area 420) where content of an image is displayed, as illustrated in FIG. 7. The specified color according to an embodiment of the disclosure may be displayed in the letterbox areas 410. As such, when the aspect ratio of the display module 160 and the aspect ratio of content do not match, the specified color may be displayed in the letterbox areas 410, which may cause a user to feel a sense of disparity.

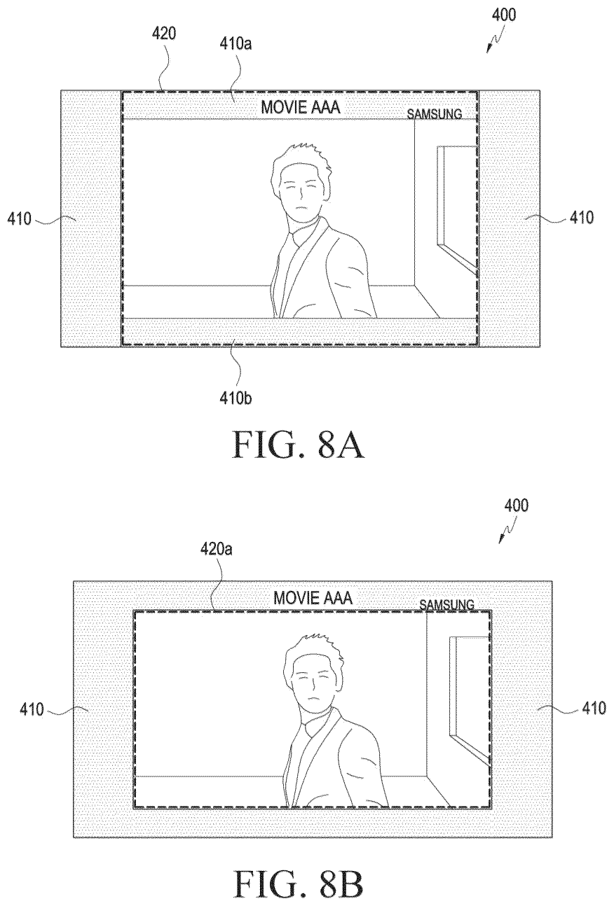

FIGS. 8A and 8B are exemplary diagrams illustrating a case in which the same color as the color displayed in the letterbox areas 410 is included in the content display area 420 according to an embodiment of the disclosure.

Referring to FIGS. 8A and 8B, an image according to an embodiment of the disclosure may include an area (e.g., a first black area 410a) in which a color (e.g., black) distinct from content displayed in the content display area 420 is displayed to provide identification information about a content provider (e.g., a logo (e.g., “SAMSUNG”) of a business that provides or produces a video and/or the title (e.g., “MOVIE AAA”) of the video). In this case, as the color substantially identical to the color displayed in the letterbox areas 410 is displayed in the content display area 420, an aspect ratio actually perceived by the user is different from an aspect ratio provided by the content provider, which may further create a sense of disparity for the user watching the video.

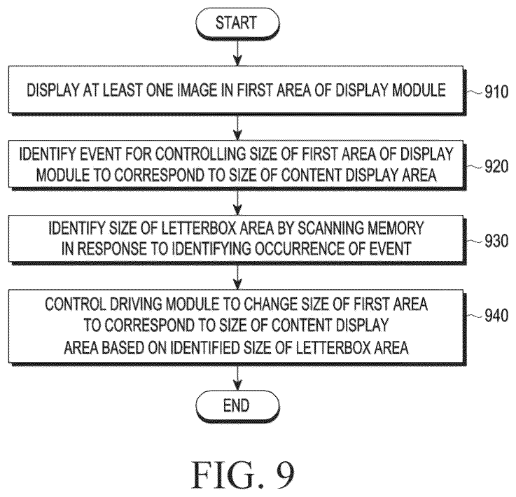

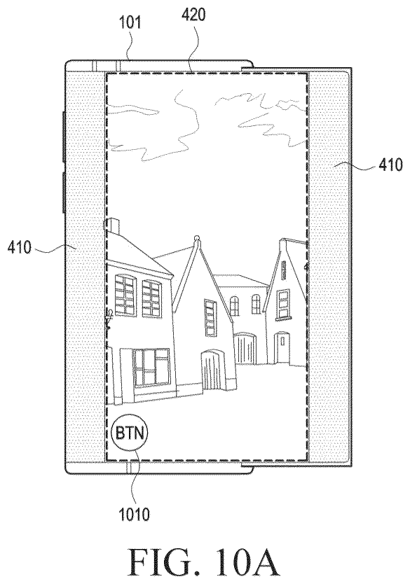

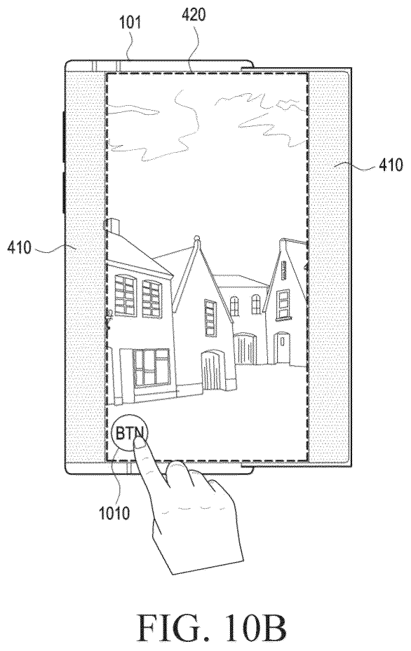

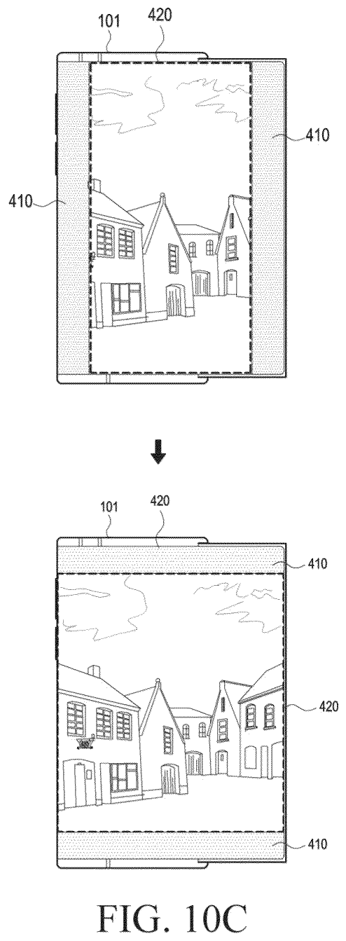

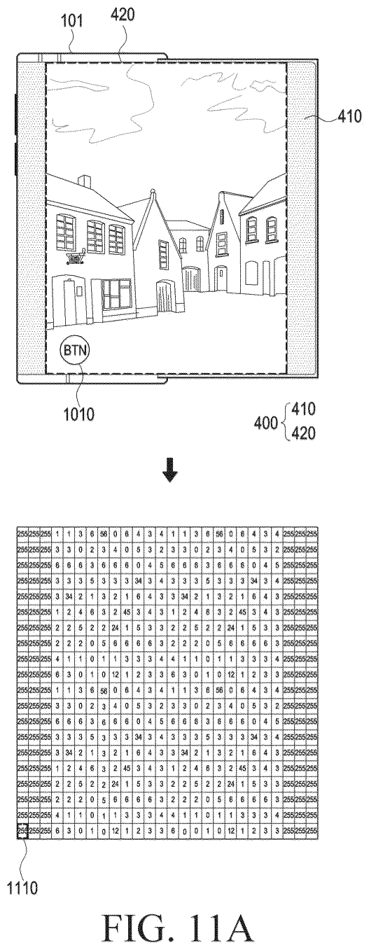

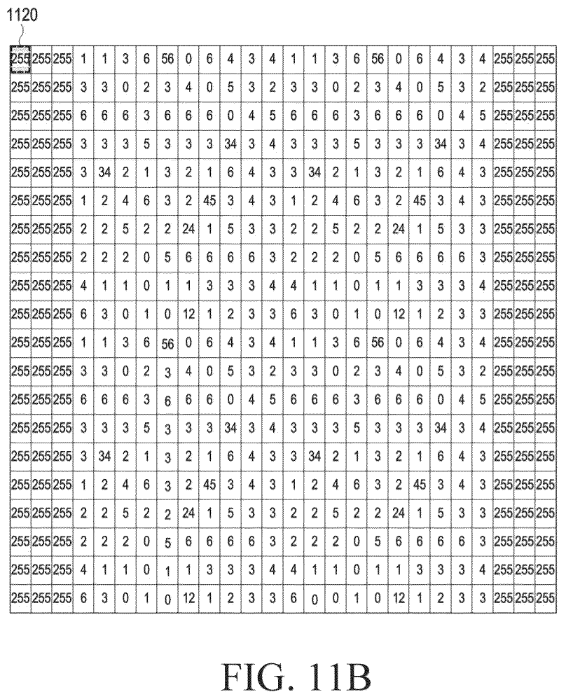

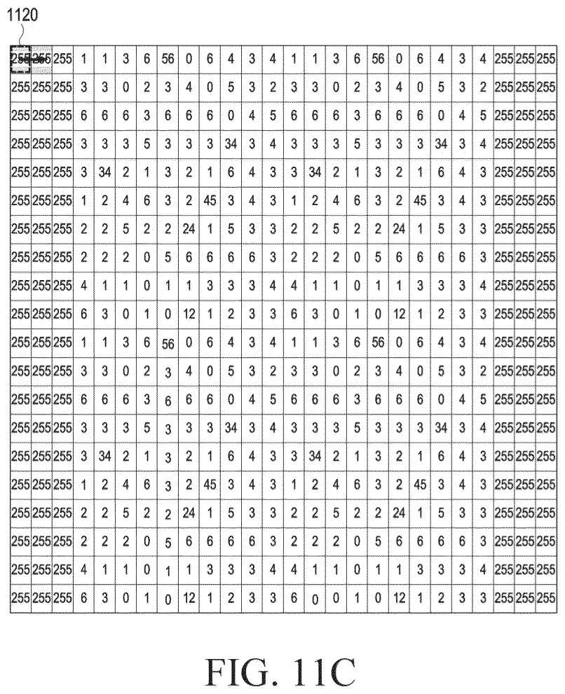

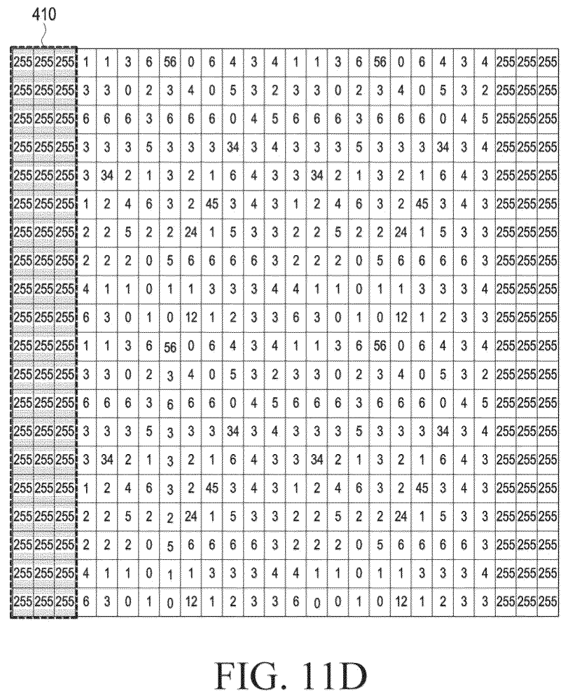

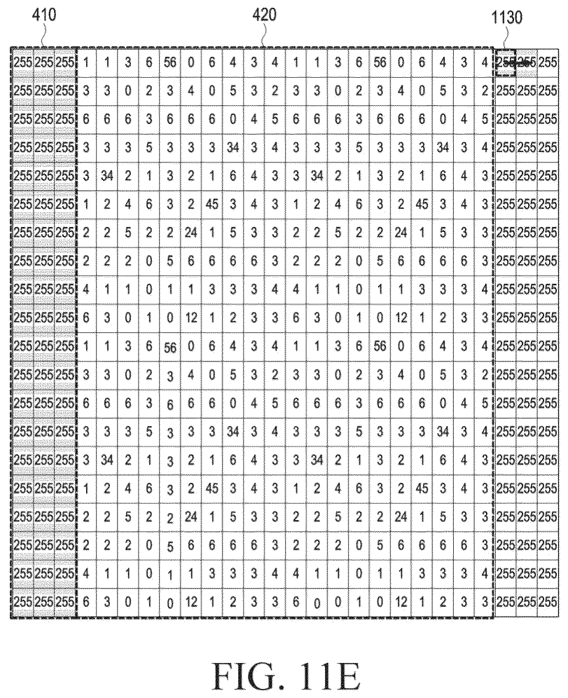

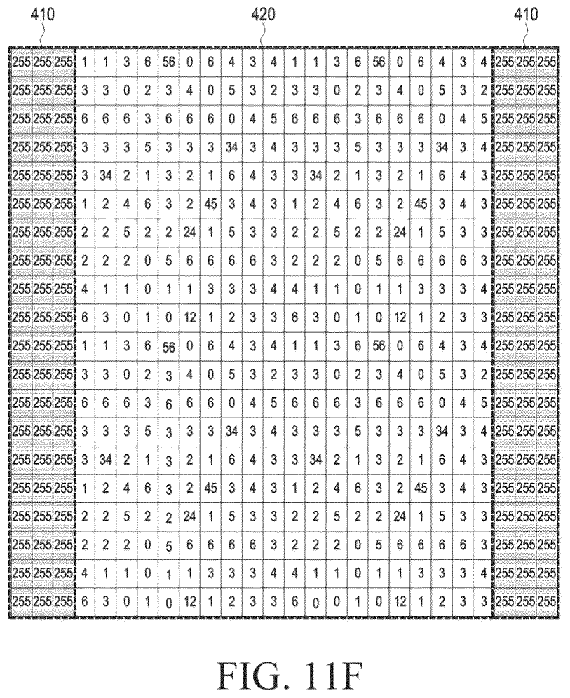

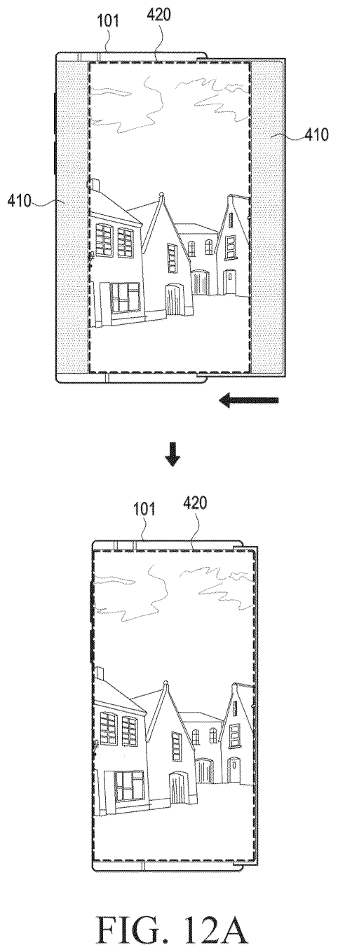

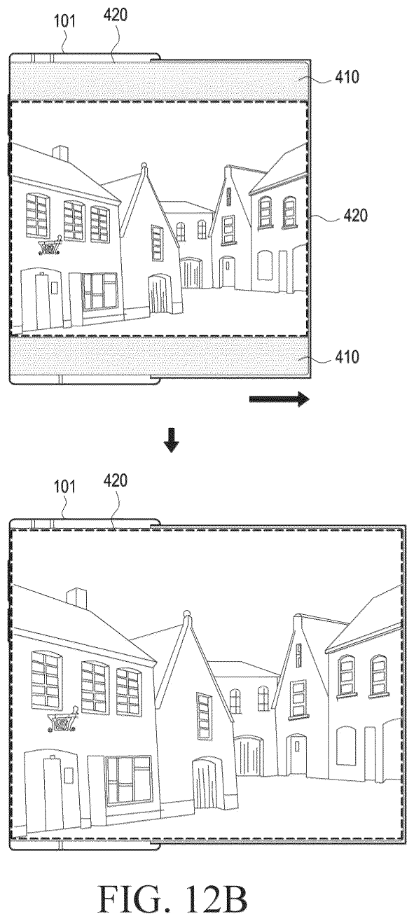

FIG. 9 is an exemplary diagram illustrating a function or operation of controlling the size of an exposed area of the display module 160 to fit the size of the content display area 420 by the electronic device 101 (e.g., the processor 120) according to an embodiment of the disclosure. FIGS. 10A to 10C are exemplary diagrams illustrating a function or operation of triggering a function or operation of controlling the size of an exposed area of the display module 160 to fit the size of the content display area 420 according to a user input by the electronic device 101 (e.g., the processor 120) according to an embodiment of the disclosure. FIG. 11A is an exemplary diagram illustrating image data (e.g., combination values of pixel intensities and/or RGB data) stored in memory (e.g., a frame buffer) in correspondence with an image being output according to an embodiment of the disclosure. FIGS. 11B to 11F are exemplary diagrams illustrating a function or operation of labeling image data according to an embodiment of the disclosure. FIG. 12A is an exemplary diagram illustrating a function or operation of controlling the size of an exposed area of a flexible display to fit the size of a content display area by reducing a horizontal length of the exposed area of the flexible display according to an embodiment of the disclosure. FIG. 12B is an exemplary diagram illustrating a function or operation of controlling the size of an exposed area of a flexible display to fit the size of a content display area by increasing a horizontal length of the exposed area of the flexible display according to an embodiment of the disclosure.

Referring to FIG. 9, the electronic device 101 according to an embodiment of the disclosure may display at least one image in a first area of a flexible display (e.g., the display module 160) in operation 910. The first area according to an embodiment of the disclosure may include an area of the display module 160, which has a specific aspect ratio (e.g., 1:1), as illustrated in FIG. 10A.

In operation 920, the electronic device 101 according to an embodiment of the disclosure may identify occurrence of an event for controlling the size of the first area of the flexible display (e.g., the display module 160) to correspond to the size of the content display area 420. The event according to an embodiment of the disclosure may include at least one of a touch input event on a visual object (e.g., a button BTN shown in FIG. 10A) displayed on the display module 160 or an event in which the sizes of the letterbox areas 410 are changed. The event in which the sizes of the letterbox areas 410 are changed according to an embodiment of the disclosure may include a case in which as a video file includes images having different aspect ratios, the images having the different aspect ratios are displayed during play of the video file, resulting in a change in the sizes and/or positions of the letterbox areas 410, as illustrated in FIG. 10C.

In operation 930, the electronic device 101 according to an embodiment of the disclosure may identify the sizes of the letterbox areas 410 (e.g., black areas) by scanning the memory 130 (e.g., a frame buffer) in response to the identification of the event in operation 920. Referring to FIG. 11A, pixel data corresponding to an image being output by the electronic device 101 may be at least temporarily stored in the memory 130 according to an embodiment of the disclosure. In FIG. 11A, each square may correspond to a pixel included in the image, and each value may represent data (e.g., a combination (e.g., average) of a pixel intensity and/or RGB data) for representing a color. According to an embodiment of the disclosure, a data value “255” illustrated in FIG. 11A may represent, for example, a black color, and as the data value is less, it may represent a lighter color. The electronic device 101 according to an embodiment of the disclosure may scan the memory 130 to identify the sizes (e.g., horizontal lengths) of the letterbox areas 410. Referring to FIG. 10, the electronic device 101 according to an embodiment of the disclosure may set pixel coordinates located in the upper left corner of the displayed image as the origin. Referring to FIG. 11B, the electronic device 101 according to an embodiment of the disclosure may determine whether a pixel data value located adjacent to the origin is “255”, in other words, whether an adjacent pixel is a pixel representing the black color. For example, when the pixel data value of a pixel (e.g., a second pixel) to the right of the origin is 255, the electronic device 101 according to an embodiment of the disclosure may determine whether the pixel data value of the second next pixel (e.g., a third pixel) to the right is 255. When the pixel data value of the second next right pixel (e.g., the third pixel) is 255, the electronic device 101 according to an embodiment of the disclosure may sequentially identify whether the pixel data value of the third next pixel (e.g., a fourth pixel) to the right is 255. When the pixel data value of the third next right pixel (e.g., the fourth pixel) is not 255, the electronic device 101 according to an embodiment of the disclosure may identify whether the pixel data value of a pixel (e.g., a fifth pixel) located below the third pixel is 255. When the pixel data value of the fifth pixel is 255, the electronic device 101 according to an embodiment of the disclosure may identify whether the pixel data value of a pixel (e.g., a sixth pixel) located to the right of the fifth pixel is 255. When the pixel data value of the sixth pixel is not 255, the electronic device 101 according to an embodiment of the disclosure may identify whether the pixel data value of a pixel (e.g., a seventh pixel) located to the left of the fifth pixel is 255. When the pixel data value of the seventh pixel is 255, the electronic device 101 according to an embodiment of the disclosure may identify whether the pixel data value of a pixel (e.g., an eighth pixel) located to the left of the seventh pixel is 255. With this sequential scanning function or operation, a letterbox area 410 formed as a closed section may be identified, as illustrated in FIG. 11D. In order to identify the content display area 420, the electronic device 101 according to an embodiment of the disclosure may set a pixel located around the boundary of the letterbox area 410 (e.g., the pixel located to the right of the third pixel, which has a pixel data value of 1) as the origin and scan pixel data, as illustrated in FIG. 11E. In this case, the electronic device 101 according to an embodiment of the disclosure may sequentially identify whether a pixel data value is not 255, as opposed to performing the function or operation of identifying the letterbox area 410. The electronic device 101 according to an embodiment of the disclosure may not identify at least some of the areas in the content display area 420 as the letterbox areas 410, even if the areas represent a predetermined color (e.g., black). In identifying the letterbox areas 410 and the content display area 410, the electronic device 101 according to an embodiment of the disclosure may identify the letterbox areas 410 and the content display area 410 based on at least one image frame. For example, even though the content display area 420 includes the same color (e.g., black) as the color of the letterbox areas 410, when only some of a plurality of image frames included in a video file include the same color (e.g., black) as the color of the letterbox areas 410, the electronic device 101 according to an embodiment of the disclosure may not identify the content display area 420 including the same color (e.g., black) as the color of the letterbox areas 410, as the letterbox areas 410. After identifying the content display area 420, the electronic device 101 according to an embodiment of the disclosure may identify a letterbox area 410 again. The electronic device 101 according to an embodiment of the disclosure may set a pixel located around the boundary of the content display area 410 as the origin pixel and sequentially scan pixel data from the origin pixel, as illustrated in FIG. 11E. According to another embodiment of the disclosure, the electronic device 101 may identify a second letterbox area 410 by setting a pixel located in the upper right corner of the image as the origin pixel after identifying the first letterbox area 410. In this case, the electronic device 101 according to an embodiment of the disclosure may identify the remaining area of the image other than the first letterbox area 410 and the second letterbox area 410 as the content display area 420. The electronic device 101 according to an embodiment of the disclosure may perform labeling on the pixel data by identifying at least one letterbox area 410 and at least one content display area 420, as illustrated in FIG. 11F. The electronic device 101 according to an embodiment of the disclosure may identify the sizes (e.g., horizontal lengths) of the letterbox areas 410 based on the labeled pixel data. The electronic device 101 according to an embodiment of the disclosure may identify the sizes (e.g., horizontal lengths) of the letterbox area 410 by calculating the number of pixels corresponding to the letterbox areas 410, because the size of one pixel is known. When the content display area 420 includes substantially the same color as the color displayed in the letterbox areas 410 in more than a predetermined proportion of the content display area 420, the electronic device 101 according to an embodiment of the disclosure may set the remaining area except for the area displaying the specified color in the content display area 420 as a new content display area 420, as illustrated in FIG. 6. In other words, when an image is displayed as illustrated in FIG. 6, the electronic device 101 according to an embodiment of the disclosure may identify both the sizes (e.g., horizontal lengths) of the letterbox areas 410 and the size (e.g., vertical length) of the area displaying the specified color, included in the content display area 420.

In operation 940, the electronic device 101 according to an embodiment of the disclosure may control a driving module (e.g., motor) to change the size of the first area to correspond to the size of the content display area 420, based on the sizes of the letterbox areas 410 identified in operation 930. For example, when the current horizontal length of the display module 160 is 15 cm and the total horizontal length of the letterbox areas 410 is 5 cm, the electronic device 101 according to an embodiment of the disclosure may control the driving module to change the horizontal length of the display module 160 to 11 cm, as illustrated in FIG. 12A. When the current vertical length of the display module 160 is 9 cm and the total vertical length of the letterbox areas 410 is 3 cm, the electronic device 101 according to an embodiment of the disclosure may control the driving module to enlarge and/or scale up an image such that the size (e.g., vertical length) of the content display area is 9 cm, and to display the enlarged image (e.g., to increase the horizontal length of the display module 160), as illustrated in FIG. 12B. For example, when the electronic device 101 according to an embodiment of the disclosure identifies that the content display area 420 has a horizontal length of 16 cm and a vertical length of 6 cm, the electronic device 101 may control the driving module to increase the vertical length of the content display area 420 by 150% and correspondingly increase the horizontal length of the display module 160 by 150%, from 16 cm to 24 cm. When an image is displayed as illustrated in FIGS. 8A and 8B, the electronic device 101 according to an embodiment of the disclosure may control the driving module to sequentially calculate a horizontal length of the display module 160 to be reduced and a horizontal length of the display module 160 to be increased, so that the display module 160 is exposed in a size substantially corresponding to the new content display area 420. The electronic device 101 according to various embodiments of the disclosure may include various sensors (e.g., a Hall sensor and/or an optical sensor) to determine an extension length of the display module 160. A method using a Hall sensor or a magnetic sensor according to various embodiments of the disclosure may include a method of measuring a change in the magnetic force of a moving magnetic body and thus measuring an absolute coordinate value for a displacement of the display module 160. An inductive method according to various embodiments of the disclosure may include a method of determining an extension length of the display module 160 by detecting a change in a magnetic field. In addition, various other techniques for determining an extension length of the display module 160 may be applicable to various embodiments of the disclosure.

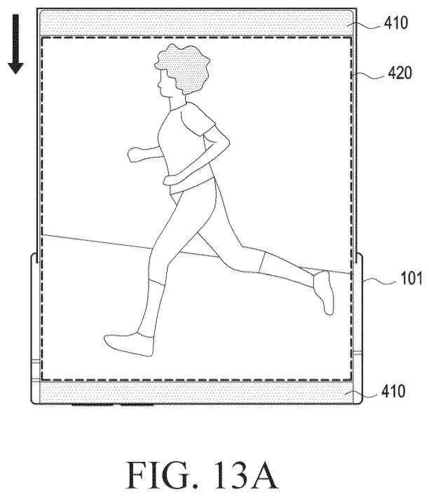

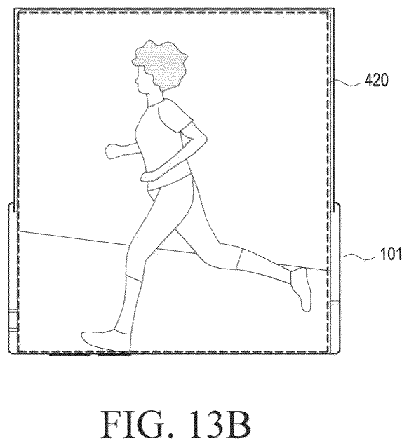

FIGS. 13A and 13B are exemplary diagrams illustrating a function or operation of controlling the driving module not to display a letterbox area by the electronic device 101, when an image is displayed in a vertical orientation (e.g., portrait orientation) according to an embodiment of the disclosure. Even when the at least one image is displayed in the vertical orientation (e.g., portrait orientation), the electronic device 101 according to an embodiment of the disclosure may control the driving module to display only the content display area 420, based on a function or operation of controlling the driving module to prevent the letterbox areas 410 from being displayed according to various embodiments of the disclosure. For example, referring to FIGS. 13A and 13B, the electronic device 101 according to an embodiment of the disclosure may reduce the vertical length of the display module 160 such that the letterbox areas 410 are not displayed. This function or operation may be equally applicable to an electronic device extending in a longitudinal direction according to other embodiments of the disclosure.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each component (e.g., a module or a program) of the above-described components may include a single entity or multiple entities, and some of the multiple entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, according to an embodiment of the disclosure, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a first housing;
a driving module including a driving motor
a second housing provided to be movable with respect to the first housing
at least one processor
memory operatively connected to the at least one processor; and
a flexible display at least partially mounted on a surface of the second housing and at least partially exposed to an outside of the electronic device, wherein a portion of the flexible display is inserted into the first housing or withdrawn out of the first housing according to a driving of the driving motor,
wherein the memory is configured to store one or more computer programs, wherein the one or more computer programs include computer-executable instructions that, when executed by the at least one processor, cause the electronic device to: display at least one image in a first area of the flexible display, wherein the at least one image includes a second area in which content of the at least one image is displayed, and a third area represented in a first color,
identify an occurrence of an event for controlling a size of the first area of the flexible display to correspond to a size of the second area,
based on identifying the event, identify a size of the second area by scanning the memory, and
control the driving module to change the size of the first area to correspond to the size of the second area, based on the identified size of the third area.

2. The electronic device of claim 1, wherein the computer-executable instructions, when executed by the at least one processor, cause the electronic device to identify a closed section corresponding to the third area by sequentially identifying pixel data stored in the memory.

3. The electronic device of claim 1, wherein the event includes at least one of an event of a touch input on a visual object displayed on the flexible display or an event of the size of the third area being changed.

4. The electronic device of claim 1, wherein the computer-executable instructions, when executed by the at least one processor, cause the electronic device to, based on a ratio of the content being less than a ratio of the first area, change the size of the first area by controlling the driving module to reduce a horizontal length of the flexible display corresponding to the third area.

5. The electronic device of claim 1, wherein the computer-executable instructions, when executed by the at least one processor, cause the electronic device to, based on a ratio of the content being larger than a ratio of the first area, change the size of the first area by controlling the driving module to increase a horizontal length of the flexible display corresponding to the third area.

6. The electronic device of claim 1, wherein the computer-executable instructions, when executed by the at least one processor, cause the electronic device to, based on the second area including the first color, control the driving module to display an image included in a remaining area except for an area including the first color.

7. The electronic device of claim 1, wherein the memory is configured to store pixel data of a black color corresponding to the first color.

8. The electronic device of claim 1, wherein the computer-executable instructions, when executed by the at least one processor, cause the electronic device to identify a length of the flexible display corresponding to the size of the third area.

9. The electronic device of claim 8, wherein the computer-executable instructions, when executed by the at least one processor, cause the electronic device to calculate a movement distance of the driving module based on the length of the flexible display corresponding to the size of the third area.

10. The electronic device of claim 1, wherein the computer-executable instructions, when executed by the at least one processor, cause the electronic device to display first content by scaling up the displayed first content in the changed first area.

11. A method for controlling an electronic device, the method comprising:
displaying at least one image in a first area of a flexible display of the electronic device, wherein the at least one image includes a second area in which content of the at least one image is displayed, and a third area represented in a first color;
identifying an occurrence of an event for controlling a size of the first area of the flexible display to correspond to a size of the first area;
based on identifying the event, identifying a size of the third area by scanning memory of the electronic device, and
controlling a driving module of the electronic device to change the size of the first area to correspond to the size of the first area, based on the identified size of the third area.

12. The method of claim 11, further comprising identifying a closed section corresponding to the third area by sequentially identifying pixel data stored in the memory.

13. The method of claim 11, wherein the event includes at least one of an event of a touch input to a visual object displayed on the flexible display or an event of the size of the third area being changed.

14. The method of claim 11, further comprising, based on a ratio of the content being less than a ratio of the first area, changing the size of the first area by controlling the driving module to reduce a horizontal length of the flexible display corresponding to the third area.

15. The method of claim 11, further comprising, based on a ratio of the content being larger than a ratio of the first area, changing the size of the first area by controlling the driving module to increase a horizontal length of the flexible display corresponding to the third area.
